(19) United States
(12) Patent Application Publication
(10) Pub. No.: US 2007/0044953 A1
(43) Pub. Date: Mar. 1, 2007

(54) Heat exchanger

(75) Inventor: Zaiqian Hu, Carmel, IN (US)

Correspondence Address: Valeo, Inc.;Intellectual Property Department, 4100 North Atlantic Boulevard, Auburn Hills, MI, 48326, US

(73) Assignee: Valeo, Inc., Auburn Hills, MI (US)

(21) Appl. No.: 11/239,611

(22) Filed: Sep. 29, 2005

Related U.S. Application Data
(60) Provisional application No. 60/713,267, filed on Aug. 31, 2005.

(51) Int. Cl. G05D 23/00

(52) U.S. Cl. 165/287

(57) ABSTRACT

The present invention relates to heat exchangers, and in particular, combo-cooler heat exchange having manifolds, tubes in fluid communication with manifold, and fins, and at least one controlling device in the manifold or manifolds that controls, via pressure or temperature differences, the flow of fluids through the controlling device. By controlling or modulating mass flow rate of heat exchanger fluids, such as refrigerants, in certain condenser tubes, combo-cooler, and, specifically, condenser element performance, is positively improved when improved performance is most needed in the motor vehicle.

This patent application claims priority of Provisional patent application 60/713,267 filed Aug. 31, 2005

### FIELD OF THE INVENTION

The present invention relates to the field of heat exchangers, and, in particular, heat exchangers useful in motor vehicle applications.

### BACKGROUND OF THE INVENTION

Heat exchangers can be of various types, including condensers, oil coolers, radiators, and the like. A combo-cooler is a module comprising one or more heat exchangers (multi-exchangers), which normally share the same frontal area when used in motor vehicle applications. For example, in a combo-cooler having a condenser element and an oil-cooler element, the oil cooler and condenser elements are usually connected to respectively identical manifolds (the same pair of manifolds), with tubes connecting the manifolds, and tubes being connected together with fins. It has been found that a module, such as a combo cooler, presents benefits over other non-combo-coolers since the modular elements can be assembled at the same time, resulting in assembly cost savings (such as core assembly and brazing costs), as well as material cost savings (only one pair of manifolds, only one pair of brackets, etc.).

Prior art heat exchangers, even when assembled as modules, have often been laid out as shown in FIG. 1. In this case, the oil cooler element is located at the top of combo-cooler related to the condenser element that is located at the bottom of the combo-cooler, when the combo cooler is oriented as it would be in a typical automotive application. In such an orientation and lay out, a oil cooler oil inlet temperatures are in about the 135 degree C. range, with oil output temperature in about the 125 degree C. range. At the same time, the condenser element experiences refrigerant inlet temperatures in about the 100 degree C. range, with refrigerant outlet temperatures in about the 64 degree C. range.

FIG. 2 shows another layout for a combo-cooler. In this case, the oil cooler element is located at the bottom of the combo cooler, and the condenser element is located at top of combo cooler. In both cases of FIGS. 1 and 2 above, because of temperature differential between oil and refrigerant, heat in the combo-cooler is conducted from the oil tube closest to the condenser tube which is closest to the oil cooler through a common fin separating the condenser and oil cooler. Because the temperature differential is smaller in the FIG. 1 case, the heat transfer is small. However, in the FIG. 2 case, because the temperature differential is large, the heat transfer is larger. This heat transfer diminishes the performance of air conditioning system.

Several solutions to this heat transfer problem of FIG. 2 have been explored, in order to reduce this un-desired heat transfer between oil cooler and condenser. For example, one may use a special type of fin separating condenser and oil cooler to try and adjust for the relatively large undesirable heat transfer. Though the idea appears interesting, the special type fins needed for this solution often have no or poor joints with the heat exchanger core tubes, and, therefore, the thermal transfer path off from oil cooler tube to condenser tube is blocked or diminished. In addition, even if efficient for the purpose of reducing inter-cooler heat transfer, the manufacturing process for such as solution is more difficult.

EU patent (0789213 A1), suggests use a dead (or in-active) tube between condenser and oil cooler between oil cooler and condenser to alleviate heat transfer problems. A so called dead tube is a tube where no refrigerant flows—therefore inter-cooler heat transfer is reduced. The advantage of this solution is manufacturing-friendly and therefore more cost competitive. However, this advantage is gained at the price of reducing condenser frontal area (loss of exchanger area normally provided by the condenser tube and fin or fins that that area), causing a so called ‘dead-zone.’

### SUMMARY OF THE INVENTION

It is desirable to have technical solution to undesirable heat transfer, and, in particular, reduction of losses via inter-cooler heat transfer, in combo coolers by manufacturing-friendly processes, while still maintaining appropriate exchange surface in the condenser area of the combo cooler. The present invention, in its various aspects, reduces the inter-cooler heat transfer, while maintaining the manufacturing and transfer area requirements for efficient combo-coolers as mentioned above.

The present invention, in broad aspects, locates a controlling device inside at least one manifold in a combo cooler. In various aspects of the present invention, the device is placed inside at least one manifold to control the fluid flow, and, in particular, the refrigerant flow from a heat exchanger tube (first tube), and, preferably a last or final condenser tube upstream or above the other type of heat exchanger tubes (second tube), in a combo cooler. Preferably, the last or final condenser tube shares a common fin with a second tube, which is an initial heat exchanger tube, and, particularly an initial oil cooler tube, located just below the first tube of, for example, a combination heat exchanger, and, preferably, an oil cooler tube. The controlling device adjusts the refrigerant flow according to the oil cooler duty. In aspects of the present invention, when the combo cooler heat exchangers or heat exchanger elements are a condenser and an oil cooler, when oil cooler duty is low, the device is to allow maximum refrigerant flow from the last condenser tube. In this case, the inter-cooler heat transfer is low, the last condenser tube contributes to the overall performance of condenser. When the oil cooler duty is high, the device is to minimize the refrigerant flow from the last condenser tube. In the latter case, only small amount of refrigerant flow is affected by the inter-cooler heat transfer, limiting the damage caused by the inter-cooler heat transfer.

A combo-cooler heat exchanger module comprising: at least one manifold; at least one first tube, and preferably, a first tube adapted to allow for the flow of refrigerant, or a condenser tube, in fluid communication with the at least one manifold; at least one second tube, and, preferably, a second tube for the flow of an oil, or oil cooler tube, in fluid communication with the at least one manifold; at least one controlling device located in the at least one manifold; and, at least one fin wherein the at least one first tube is located above the at least one second tube. Preferably, the at least one first tube is connected to the at least one second tube by the at least one fin.

The present invention has the advantages of decreasing un-desirables heat transfer while maintaining an effective front area of condenser. In various aspects of the present invention, advantages such as limiting mass flow rate of refrigerant affected by the inter-cooler heat transfer, also are important.

In specific embodiments where oil cooler or TOC tubes are present, and where the controlling device depends on the TOC thermal duty, the relationship between TOC thermal duty changes, and condenser thermal duty are positive. In particular aspects of the present invention, particularly wherein heat exchanger tubes include oil cooler and condenser tubes, in a plurality or bank of tubes, the last condenser tube has refrigerant that is thermally affected by two thermal sources: relatively cool air flow and inter-cooler heat transfer. The former cools the refrigerant and the latter warms refrigerant up. When TOC duty is low, the inter-cooler heat transfer is low, and the refrigerant in the last condenser tube is mainly influenced by the cooler air, therefore has positive contribution to the overall condenser performance. According to preferred aspects of the present invention, the mass flow rate of refrigerant in the last condenser tube is high; maximizing its positive contribution to the overall condenser performance.

At 35 KPH with towed trailer, the TOC duty is at its maximum level. In this case the inter-cooler heat transfer is at its maximum level, and its influence may be bigger than the air cooling effect on the last condenser tube, and consequently the refrigerant in the last condenser tube may be warmed up, making negative contribution to the overall condenser performance. According to present invention, at this time, the device reduces the refrigerant mass flow rate in the last condenser tube, minimizes its negative contribution.

In various aspects of the present invention, and particularly where condenser duty is less important and where condenser performance is higher because of the higher air speed at different levels of operation, the reduced mass flow rate of the last condenser tube, makes the inter-cooler heat transfer less critical.

Overall, a device according to one aspect of the present invention modulates the mass flow rate of refrigerant in the last condenser tube, so that when TOC duty is low, the last condenser tube contributes positively to the overall condenser performance. This positive contribution is important because this is the moment the condenser duty is high. Later, when TOC duty is high, in preferred aspects of the present invention, the controlling device reduces the negative contribution from the refrigerant flow of last condenser tube, when the condenser duty is reduced.

The present invention, in its various aspects, allows the last condenser tube to contribute positively to the overall condenser performance when the performance is most needed.

From the above examples, in preferred aspects of the present invention, the baffle with the calibrated hole can control the mass flow rate of refrigerant based on the inter-cooler heat duty.

### BRIEF DESCRIPTION OF THE DRAWINGS

FIG. 1 shows a frontal schematic view of two manifolds of a combo-cooler with an oil cooler portion or element and a condenser portion or element, with the oil cooler element on top of the condenser element.

FIG. 2 shows a frontal schematic view of two manifolds of a combo-cooler with an oil cooler portion or element and a condenser portion or element, with the condenser element on top of the oil cooler element.

FIG. 3 shows a frontal schematic view of two manifolds of a combo-cooler, with an oil cooler element and a condenser element, with the oil cooler element below the condenser element, and with at least one oil cooler and at least one condenser tube connected by a fin, and a controlling device, in accordance with an aspect of the present invention.

FIG. 4 shows a graphic representation of heat exchanger performance in relation to condenser and oil element duty and air mass flow at different KPH and temperatures.

FIG. 5 shows a frontal schematic view of two manifolds of a combo-cooler, with an oil cooler element and a condenser element, with the oil cooler element below the condenser element, and with at least one oil cooler and at least one condenser tube connected by a fin, and a controlling device comprising a baffle with a calibrated hole, in accordance with an aspect of the present invention.

FIG. 6 shows a frontal schematic view of two manifolds of a combo-cooler, an oil cooler element and a condenser element, with a condenser outlet, with the oil cooler element below the condenser element, and with at least one oil cooler and at least one condenser tube connected by a fin, and a thermally sensitive controlling device, in accordance with an aspect of the present invention.

### DETAIL DESCRIPTION OF THE EMBODIMENTS OF THE INVENTION

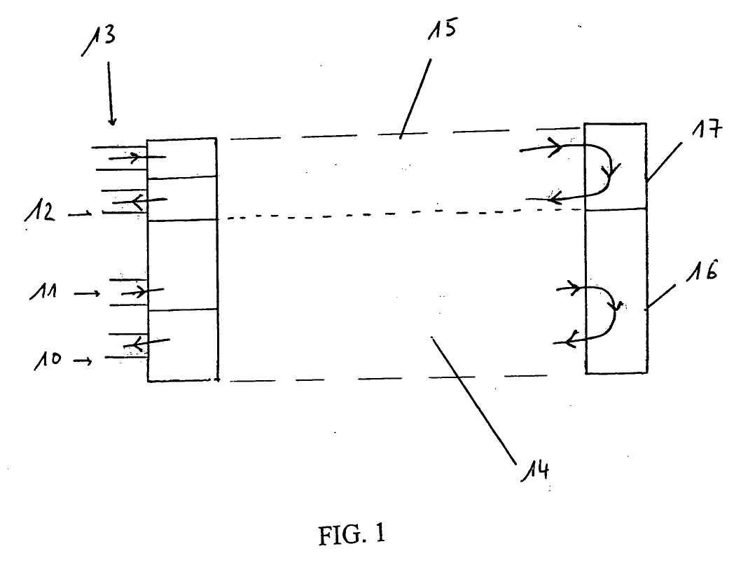

Referring to FIG. 1, manifold inlet (13) and outlet (12) for oil cooler element (15) is shown, with oil cooler section of manifold (17) described. Condenser section of manifold (16) is also shown with oil cooler element (15) above condenser element (14).

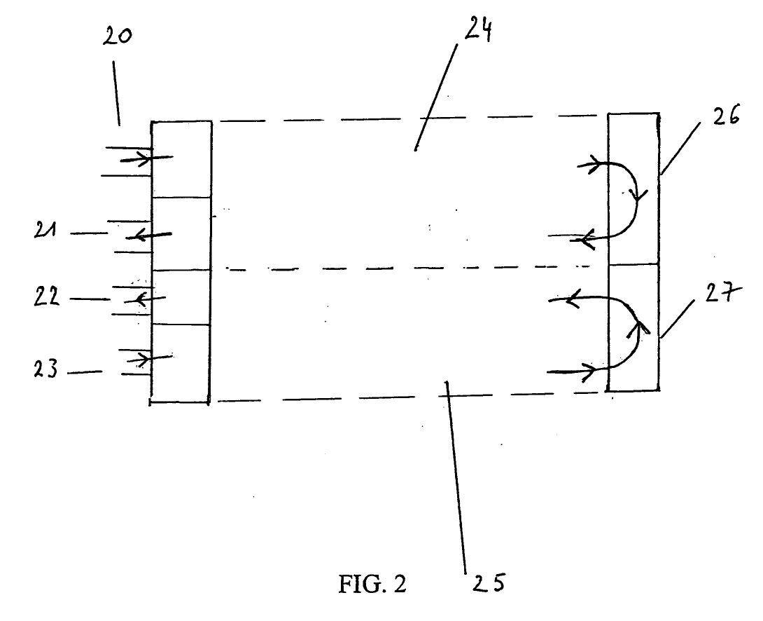

Referring to FIG. 2, manifold inlet (23) and outlet (24) for oil cooler element (25) is shown, with oil cooler section of manifold (27) described. Condenser section of manifold (26) is also shown with oil cooler element (25) below condenser element (24).

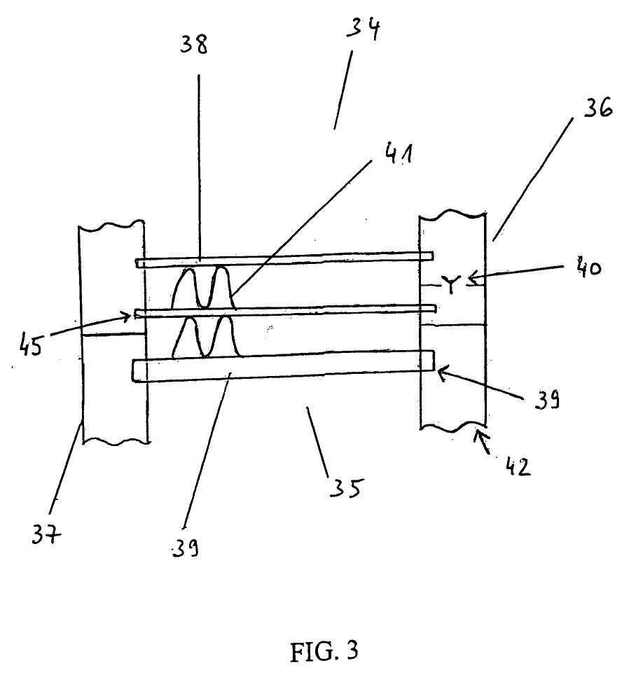

Referring to FIG. 3, a combo-cooler (34), a controlling device (40) controlling mass flow rate through the last condenser tube (45) prior to leaving the condenser portion is shown.

FIG. 3 shows a condenser element (38) and transmission oil cooler element last tube (39). Manifold (37) and manifold tube portions (36,42) are illustrated as well as fins (41).

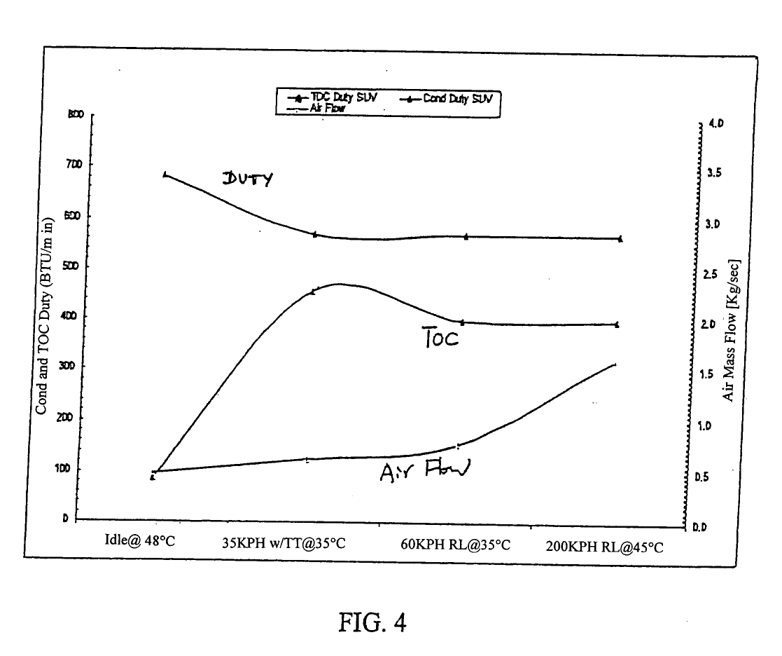

Referring to FIG. 4, is shown a thermal duty map graphic representation of performance of a sport-utility vehicle (SUV) (not shown) having a condenser and oil cooler (TOC). The X-axis illustrates 4 typical load conditions. The Y-axis illustrates the thermal duty requirement.

As seen in FIG. 4, when the SUV is at idle, the TOC duty is at its lowest level, and condenser duty is at its maximum level. As vehicle speed increases to 35 KPH (kilometer per hour) (with towed trailer), the TOC duty reaches its maximum, and at the same time, condenser duty is reduced considerably. As vehicle speed continuously increases, TOC duty is reduced and then stabilized, while condenser duty is stabilized.

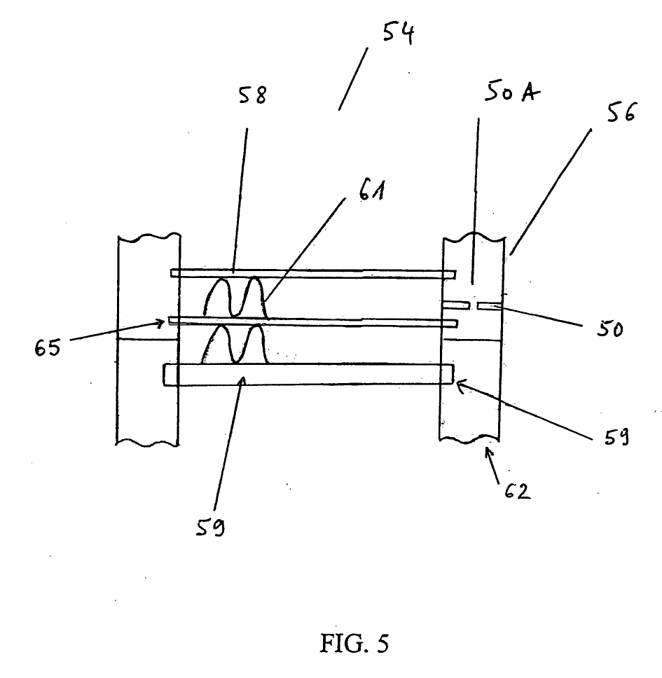

Referring to FIG. 5 is shown a schematic view of the controlling device consisting of baffle (50) with a calibrated hole (50A) as controlling device inside manifold (56) having condenser tube (58). FIG. 5 additionally illustrates the device controlling the mass flow rate of refrigerant through the last condenser tube (65). The baffle (50) with a calibrated hole (50A) is placed between the last condenser tube (65) and second to the last condenser tube (58) inside the outlet manifold (56). In preferred aspects of the present invention, the pressure differential is monitored and the controlling device controls the refrigerant flow through the last condenser tube, depending on this differential.

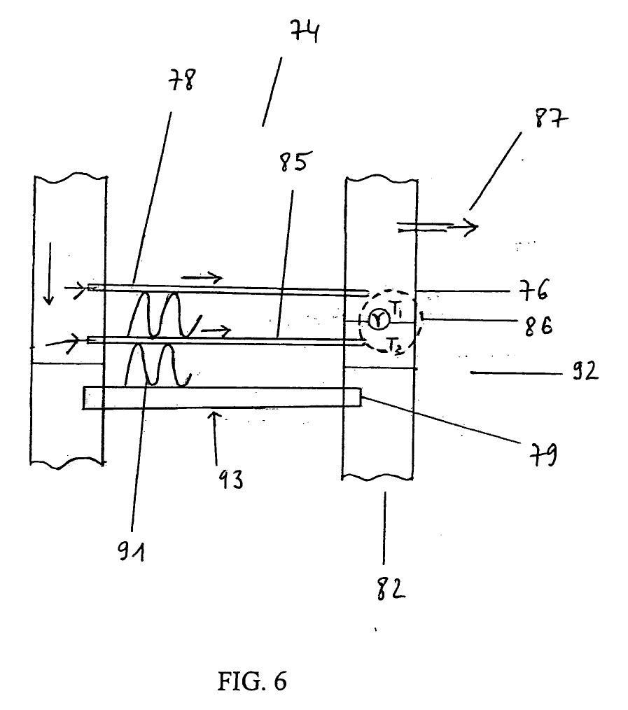

Referring to FIG. 6 is shown an aspect of the present invention using temperature differential (T2-T1) to control the opening of the controlling device. When there is no temperature differential on the two sides (T1, T2) of the device, the opening is at its maximum. When the temperature differential is large, the opening is at its minimum. FIG. 6 shows temperature related controlling device (86) uses the temperature differential on both sides of the device to change the opening for the refrigerant passing through the last condenser tube (85).

Also shown are condenser outlet (87) and manifold portions (76, 82), double baffle (92), and initial oil cooler tube (79) and fin (91) between last condenser tube (85) and initial oil cooler tube (93).

In aspects of the present invention, the controlling device uses the difference of pressure between two sides of device to change the mass flow rate of refrigerant through the last condenser tube.

In aspects of the present invention wherein the passage area of the calibrated hole is much smaller than the cross section of the manifold, the mass flow rate there through is reduced. In preferred aspects of the present invention, the cross section of the hole is slightly smaller than the refrigerant cross section of the last condenser tube. In preferred aspects of the present invention, the presence of the restriction of free passage, by the calibrated hole, consists of /causes a pressure drop. The pressure drop allows for the last condenser tube to have less mass flow rate of refrigerant than other tubes in the sub-cooling pass.

In preferred aspects of the present invention wherein the controlling device has a calibrated hole, the size of area (A) of the calibrated hole is important to effectively control the mass flow rate of refrigerant through the last tube. When it is too big, its effect is not evident, i.e. the change of mass flow rate will be too small even when the inter-cooler heat transfer is high. When it is too small, it will reduce the mass flow rate even when the inter-cooler heat transfer is low.

The range of A is related to the free passage area A_{tube} of the last condenser tube. Preferred is a ratio of A/A_{tube} between ⅕ and 3. In other preferred aspects, the ratio is between about ¼ and 2.

When the hole size is too small (compares to the baffle gauge), it is difficult to produce it cost-effectively. The present invention, therefore, in various aspects, has a ratio of area size and baffle gauge of greater than or equal to about 0.5—in other words, between area size (diameter, for example) and the baffle gauge, the ratio is equal to, or preferably greater than, 0.5. Therefore, in various aspects of the present invention, the diameter of the calibrated hole is greater than or equal to half of the gauge of the baffle.

The controlling device may be located in a number of locations in the heat exchanger manifold. Preferably, the controlling device is placed downstream of the last condenser tube. In order to detect the inter-cooler heat transfer, in our preferred embodiment, the controlling device is placed at the downstream of last condenser tube.

In embodiments of the present invention wherein the controlling device has a calibrated hole, the gauge of the baffle having the calibrated hole or holes is smaller than the height of the fin, in order to be placed between tubes inside manifold.

The controlling device, as described above, can be in the inlet manifold, or outlet manifold, or in both the inlet manifold and outlet manifold.

The controlling device can be also made of a baffle with several calibrated holes. In this case, the sum of areas of the calibrated holes should be within the same range as stated above, regarding to the A_{tube}.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A combo-cooler heat exchanger module comprising:
a. at least one manifold;
b. at least one first tube in fluid communication with the at least one manifold;
c. at least one second tube in fluid communication with the at least one manifold;
d. at least one controlling device located in the at least one manifold; and,
e. at least one fin,
wherein the at least one first tube is located above the at least one second tube.

2. A combo-cooler heat exchanger module as in claim 1, wherein the at least one first tube is adapted to have a refrigerant flow therethrough and the at least one second tube is adapted to have an oil flow therethrough.

3. A combo-cooler heat exchanger module as in claim 2, wherein the controlling device changes fluid mass flow rate from the manifold into a first or second tube.

4. A combo-cooler heat exchanger module as in claim 1, wherein the controlling device is a baffle with a calibrated hole.

5. A combo-cooler heat exchanger module as in claim 1, wherein the first tube is a condenser tube.

6. A combo-cooler heat exchanger module as in claim 1, wherein the at least one second tube is an initial oil cooler tube.

7. A combo-cooler heat exchanger module as in claim 1, wherein the at least one second tube is an oil cooler tube.

8. A combo-cooler heat exchanger module as in claim 7, wherein the at least one first tube is a last or final condenser tube.

9. A combo-cooler heat exchanger module as in claim 7, wherein the controlling device comprises a baffle with a calibrated hole.

10. A combo-cooler heat exchanger module as in claim 9, wherein the ratio of the area of the calibrated hole and A_{tube} is between about 0.20 and about 3.0.

11. A combo-cooler heat exchanger module as in claim 10, wherein the ratio of the area of the calibrated hold to A_{tube} is between about 0.25 and about 2.0.

12. A combo-cooler heat exchanger module as in claim 9, wherein the fin contacts the at least one first tube and the at least one second tube, the gauge of the baffle is smaller than the height of the fin, and the diameter of the calibrated hole is greater than or equal to half of the gauge of the baffle.

13. A combo-cooler heat exchanger module as in claim 1, wherein the controlling device is a temperature sensitive device.

14. A combo-cooler hear exchange module as in claim 13, wherein the temperature sensitive device senses the temperature differential on either side of the device.

15. A combo-cooler heat exchange module as in claim 14, wherein the temperature sensitive device comprises a variable opening.

16. A combo-cooler heat exchanger module as in claim 15, wherein the variable opening is reduced relative to a predetermined norm in size when the sensed temperature differential is large, and increased in size relative to the predetermined norm when the temperature differential is small.

17. A combo-cooler heat exchanger module as in claim 5, wherein the module has at least two manifolds.

18. A combo-cooler heat exchanger module as in claim 17, wherein there is at least one first tube essentially in parallel with at least one second tube.

19. A combo-cooler heat exchanger module as in claim 18, wherein the at least one first tube is different from the at least one second tube and the at least one first tube and the at least one second tube are both connected to the at least one fin.

20. A combo-cooler heat exchanger module as in claim 19, wherein the at least one first tube and the at least one second tube are essentially parallel to one another and the at least one first tube and the at least one second tube are in fluid communication with the at least one first manifold and the at least one second manifold respectively.

21. A combo-cooler heat exchanger module as in claim 20, wherein the fluid flowing through the least one first tube is a refrigerant, and wherein the fluid flowing through the at least one second tube is an oil.

22. A combo-cooler heat exchanger module as in the claim 21, the controlling device is placed to control the refrigerant flow rate through the at least one first tube and the at least one first tube is a last condenser tube.

23. A combo-cooler heat exchanger module as in claim 21, wherein at least one controlling device is place in the at least one first manifold and the at least one second manifold.

24. A combo-cooler heat exchanger module as in claim 3, wherein the at least one first tube is a last or final condenser tube.

25. A combo-cooler heat exchanger module as in claim 24, wherein the at least one second tube is a an initial oil cooler tube, and the at least one fin is between the last or final condenser tube and the initial oil cooler tube.
